(19) United States
(12) Patent Application Publication
(10) Pub. No.: US 2006/0073287 A1
(43) Pub. Date: Apr. 6, 2006

(54) Recording medium

(76) Inventors: Takahiro Tsutsui, Ibaraki (JP); Hiroshi Kakihira, Ibaraki (JP)

Correspondence Address: HARNESS, DICKEY & PIERCE, P.L.C., P.O. BOX 8910, RESTON, VA, 20195, US

(21) Appl. No.: 10/535,135

(22) PCT Filed: Dec. 24, 2003
(86) PCT No.: PCT/JP03/16605

§ 371 Date: May 17, 2005

(30) Foreign Application Priority Data
Dec. 25, 2002 (JP) 2002-375361

(51) Int. Cl. B41M 5/00

(52) U.S. Cl. 428/32.34

(57) ABSTRACT

A recording medium is provided on at least one of its opposite sides with at least one ink-receiving layer. The ink-receiving layer contains an inorganic pigment, a water-soluble resin and/or water-dispersible resin, thiodipropionic acid or its salt, and tocopherol or its derivative.

### TECHNICAL FIELD

This invention relates to recording media suitable for performing recording with ink, and especially to recording media which, when applied to printers or plotters making use of ink-jet recording, exhibit excellent ink absorption properties and can form images having high print density, equipped with print quality comparable with silver halide pictures, and protected from fading or discoloration by acidic gas in the air and/or light so that they are reduced in the alteration of the cyan tone.

### BACKGROUND ART

Inkjet recording is a recording technique that performs recording of an image, characters or the like by causing tiny droplets of ink to fly in accordance with one of various operation principles and then allowing them to adhere on a recording medium such as paper. Inkjet recording features high-speed printing performance, low operating noise, applicability for the recording of a wide variety of characters and patterns, easy multicolor printing, and obviation of development and image fixing. In particular, an image formed by multicolor inkjet recording can provide a record which is no way inferior to an image printed by multicolor printing making use of a form-plate-dependent printing technique or by a color photographic technique. Multicolor inkjet recording has a still further merit in that, when the number of copies or prints to be made is small, it requires lower printing cost than an ordinary printing technique or photographic technique. Multicolor inkjet recording is, therefore, rapidly finding wide-spread utility as image recorders for various information equipment in recent years. For example, multicolor inkjet recording is finding increasing utility in a wide variety of fields in which recording of full-color images is required, for example, output of image designs in design business, production of color block copies in a printing field where the quality of photographic images is required, and production of billboards and catalogs which are frequently updated.

In such ink-jet recording, improvements have been made in recording systems and recording methods to improve recording characteristics, for example, to achieve high-speed recording, high-definition recording and full-color recording. Keeping in step with such improvements, an increasing demand has also arisen for recording media of still higher characteristics. Described specifically, characteristics which recording media are required to possess include that printed dots can have high density and can produce vivid and bright tones, that high contrast can be produced, that ink absorption properties are so high that, even when printed dots overlap, ink does not run off or bleed, that spreading or diffusion of ink in horizontal direction does not occur beyond necessity and printed dots have a shape close to a true circle, and that dot edges are smooth and are well defined.

To meet these requirements, certain proposals have been made to date. Proposed include, for example, recording media in each of which a fine aluminum hydrate is coated together with a water-soluble binder on a base material. JP 60-232990 A discloses a recording paper provided with a coating layer which contains a porous cationic aluminum hydrate. In JP 2-276670 A, JP6-48016 A, JP6-55829 A, JP7-76161 A, JP8-22608 A, JP 10-44585 A, JP11-34484 A and JP2000-239578 A, recording sheets containing aluminum hydrates having the pseudo-boehmite structure are disclosed. In particular, JP 7-76161 A and JP 2000-239578 A disclose recording sheets containing an alumina sol of the pseudo-boehmite structure and boric acid or a salt thereof. Recording media with such inorganic pigments contained therein include a number of voids so that they are excellent in ink absorption properties and also in gloss. They can, therefore, provide images comparable in quality with silver halide pictures. By acidic gas in the air such as ozone, nitrogen oxides and sulfur oxides, however, these images are substantially discolored or faded, and in severe instances, the color perceptions of the images may be altered as quickly as less than a week.

To avoid such problems as described above, recording media with various antioxidants, ultraviolet absorbers, light stabilizers and the like contained therein have been proposed.

With a view to making improvements in gas fastness, JP 61-154989 A discloses a recording medium with a hydrazide compound contained therein, and JP 4-34953 B and JP 7-314883 A disclose recording media with thiourea derivatives, thiosemicarbazide derivatives, thiocarbohydrazide derivatives, or the like contained therein. JP 8-25796 A, on the other hand, discloses a recording medium, which contains an additive selected from a thiourea derivative, a thiosemicarbazide derivative or a thiocarbohydrazide derivative and also, another additive selected from iodine, an iodide, a dithiocarbamic acid, a thiocyanate salt or a thiocyanate ester.

As a method for making an improvement in light fastness, JP 57-87989 A, JP57-74192, JP 60-72785 A, JP 61-146591 A and JP2002-103807 disclose recording media, each of which contains a phenolic antioxidant and a benzophenone or benzotriazole ultraviolet absorber. Further, JP 61-146591 A discloses a recording medium containing a hindered amine compound, and JP 61-154989 A discloses a recording medium containing a hydrazide compound.

The above-mentioned compounds, which are stated to improve gas fastness and light fastness, are recognized to be effective to certain extent insofar as only one of these fastness is concerned. In many instances, however, they are ineffective for the other fastness or conversely, may deteriorate the other fastness. It has, therefore, been difficult to improve both of the fastness to acidic gas in the air and the fastness to light, which are primary causes of image discoloration and fading.

Concerning the above-described problem, JP 2002-103807 A discloses recording media which contain thiodipropionic acids as compounds capable of improving both of the properties, i.e., gas fastness and light fastness.

These compounds are recognized to exhibit certain effects on both gas fastness and light fastness, but are accompanied by a problem in that, when inkjet recording is actually performed on recording media containing these compounds, cyan turns to a color tone close to green.

In recent years where printers are finding increasing utility in outputting photographic images recorded by digital cameras, the above-described tone alteration of cyan has become a serious drawback in that, when a photographed image of a landscape or the like is outputted, the color of the sky, sea or the like becomes dull and hence, the picture so printed is dark as a whole, lacks vividness and gives a considerably altered impression. It is, therefore, difficult to provide an image improved in both gas fastness and light fastness without altering its color tone or impression. Nonetheless, there is a strong demand for the elimination or lessening of the above-described drawback.

### DISCLOSURE OF THE INVENTION

With the foregoing circumstances in view, the present invention has as an object thereof the provision of a recording medium which, when applied to a printer or plotter making use of ink-jet recording, exhibits excellent ink absorption properties and can form images having high print density, equipped with print quality comparable with silver halide pictures, and protected from fading or discoloration by acidic gas in the air and/or light so that they are reduced in the alteration of color tone, especially of the cyan tone.

The present inventors have proceeded with a variety of investigations to obtain a recording medium which, when applied to a printer or plotter making use of ink-jet recording, exhibits excellent ink absorption properties and can form images having high print density, equipped with print quality comparable with silver halide pictures, and protected from fading or discoloration by acidic gas in the air and/or light so that they are reduced in the alteration of color tone, especially of the cyan tone. As a result, it has been found that in a recording medium provided with an ink-receiving layer containing an inorganic pigment and a water-soluble resin and/or water-dispersible resin as principal components, incorporation of thiodipropionic acid or a salt thereof and tocopherol or a derivative thereof in the ink-receiving layer can solve the above-mentioned problems, leading to the completion of the present invention.

Described specifically, the present invention provides a recording medium provided on at least one of opposite sides thereof with at least one ink-receiving layer, characterized in that the ink-receiving layer comprises an inorganic pigment, a water-soluble resin and/or water-dispersible resin, thiodipropionic acid or a salt thereof, and tocopherol or a derivative thereof.

Preferably, thiodipropionic acid or its salt and tocopherol or its derivative can be added in a total proportion of from 1 to 20 wt. % based on the inorganic pigment.

Further, the inorganic pigment can preferably be an aluminum hydrate having the boehmite or pseudo-boehmite structure. A water dispersion of the aluminum hydrate can preferably have a zeta (ζ) potential of +40 mV or higher at pH3.5 to 4.5. Preferably, the ink-receiving layer can further comprise a boron compound.

The recording medium according to the present invention, which is provided with the above-described ink-receiving layer, exhibits excellent ink absorption properties and can form images having high print density, equipped with print quality comparable with silver halide pictures, and protected from fading or discoloration by acidic gas in the air and/or light so that they are reduced in the alteration of color tone, especially of the cyan tone.

### BEST MODE FOR CARRYING OUT THE INVENTION

Based on certain preferred embodiments, the present invention will next be described in further detail.

(Base Material)

Although no particular limitation is imposed on the base material for use in the present invention, usable examples of the base material include papers such as high-quality paper, medium-quality paper, coated paper, art paper and cast-coated paper, synthetic paper, white plastic films, transparent plastic films, translucent plastic films, and resin coated paper. Preferred are laminated paper formed by coating a base paper stock with a thermoplastic resin composition (resin-coated paper), white plastic films, and the like.

To make the recording medium show a gloss more effectively, a base material having high barrier property to a water-based composition to be applied to form the ink-receiving layer is preferred. Preferred examples include white plastic films of polyethylene terephthalate, polyvinyl chloride, a polycarbonate, a polyimide, a polyacetate, polyethylene, polystyrene, polypropylene or the like, which has been opacified by adding a pigment such as titanium oxide or barium sulfate or making it porous, and so-called resin-coated paper obtained by laminating a thermoplastic resin such as polyethylene or polypropylene on a paper base material.

As the base material in the recording medium according to the present invention, preferably usable is polyolefin-resin-coated paper coated on at least one side thereof on which the ink-receiving layer is to be arranged, and more preferred is polyolefin-coated paper both sides of which are coated. Preferred examples of the polyolefin-coated paper have a centerline average roughness of 0.5 μm or smaller as measured by JIS-B0601 and a 75-deg. specular gloss of from 30 to 80% as measured by JIS-P8142.

No particular limitation is imposed on the thickness of the base material, although it may preferably be from 25 to 500 μm, with 50 to 300 μm being more preferred. A thickness smaller than 25 μm may result in an inkjet recording medium which has low stiffness and may develop inconvenience such as a reduction in touch feeling, texture or opacity. A thickness greater than 500 μm, on the other hand, may lead to excessively high stiffness so that the base material may not be handled with easy and may cause a trouble when fed to and running on a printer. The weight of the base material may preferably be within a range of from 30 to 500 g/m² although no particular limitation is imposed thereon.

As the base material, a glass or metal sheet or the like may also be used. To improve the adhesion strength between these base materials and the ink-receiving layers, corona discharge treatment or various undercoating treatments can be applied to surfaces of these base materials.

(Inorganic Pigment)

Examples of the inorganic pigment for use in the present invention include light calcium carbonate, heavy calcium carbonate, magnesium carbonate, kaolin, clay, talc, calcium sulfate, zinc hydroxide, zinc sulfide, zinc carbonate, hydrotalcite, aluminum silicate, diatomaceous earth, calcium silicate, magnesium silicate, synthetic amorphous silica, colloidal silica, lithopone, zeolite, alumina, aluminum hydroxide, and aluminum hydrates of the boehmite structure or pseudo-boehmite structure. These inorganic pigments can be used either singly or in combination.

Among the above-described inorganic pigments, aluminum hydrates of the boehmite structure or pseudo-boehmite structure are preferred for use in the present invention because they have high ink absorbency and excellent color producibility and permit formation of images of high quality.

As the form of the aluminum hydrate of the boehmite or pseudo-boehmite structure, its average particle size polydisperse index (μ/<Γ>²) may be preferably in a range of from 150 nm to 250 nm and in a range of from 0.01 to 0.20, respectively, more preferably in a range of from 160 nm to 230 nm and in a range of from 0.01 to 0.18, respectively, for obtaining an ink-receiving layer of high gloss and high transparency. An aluminum hydrate the average particle size of which is smaller than 150 nm leads to an ink-receiving layer with reduced ink absorption properties so that, when printed by a printer of high ejection rate or a printer of high output speed, bleeding or beading may occur. An average particle size greater than 250 nm, on the other hand, results in an ink-receiving layer lowered in transparency and also reduced in gas fastness. Further, a polydisperse index greater than 0.20 may lead to an ink-receiving layer reduced in transparency, print density and gloss as in the case of average particle size.

Incidentally, each “average particle size” and “polydisperse index” as referred to herein can be measured by the dynamic light scattering method, and can be determined from analyses making use of the cumlant method described in “Polymer Structures (2), Scattering Experiments and Form Observations, Chapter 1: Light Scattering” (KYORITSU SHUPPAN CO., LTD.; Compiled by The Society of Polymer Science, Japan) or “J. Chem. Phys., 70(B), 15 Apl., 3965 (1979)”. According to the theory of dynamic light scattering, there is a distribution in decays of a time correlation function obtained from intensities of scattered light where fine particles having different particle sizes exist as an admixture. An analysis of the time correlation function in accordance with the cumlant method makes it possible to determine the mean (Γ) and dispersion (μ) of decay rates. As the decay rates (Γ) are expressed by a function of diffusion coefficients and scattering vectors of particles, a hydrodynamic average particle size can be determined using the Stokes-Einstein equation. Therefore, the polydisperse index (μ/<Γ>²) obtained by dividing the dispersion (μ) of decay rates with a square of the average (<Γ>²) indicates the degree of distribution of particle sizes. It is meant that the distribution of particle sizes becomes narrower as the value of the polydisperse index (μ/<Γ>²) approaches 0. Each average particle size and polydisperse index defined in the present invention can be readily measured by using, for example, a laser diffraction particle size analyzer, “PARIII” (trade name, manufactured by OTSUKA ELECTRONICS CO., LTD.), or the like.

Aluminum hydrates, which have the boehmite structure or the pseudo-boehmite structure and are preferably usable in the present invention are represented by the following formula (1)
Al₂O₃₋ₙ(OH)₂ₙ.mH₂O (1)
wherein n stands for any one of integers 0, 1, 2 and 3, and m stands for a value of from 0 to 10, preferably from 0 to 5. Because mH₂O represents a removable water phase which may not take part in the formation of a crystal lattice in many instances, m can stands for a value which is not an integer. It is to be noted that m may reach the value of 0 when an aluminium hydrate of this sort is subjected to calcination.

In general, an aluminium hydrate showing the boehmite structure is a layer compound the (020) crystal plane of which forms a huge plane, and shows a particular diffraction peak in its X-ray diffraction pattern. As the boehmite structure, it is possible to take, in addition to complete boehmite structure, a structure containing excess water between layers of (020) planes and called “pseudo-boehmite”. An X-ray diffraction pattern of this pseudo-boehmite shows a broader diffraction peak than complete boehmite. As complete boehmite and pseudo-boehmite are not clearly distinguishable from each other, they will hereinafter be collectively called an aluminium hydrate showing the boehmite structure unless otherwise specifically indicated.

No particular limitation is imposed on the process for the production of an aluminum hydrate which has the boehmite structure and is suitable usable in the present invention. It can, therefore, be produced by any known process insofar as it can produce an aluminum hydrate having the boehmite structure, for example, by hydrolysis of an aluminum alkoxide or hydrolysis of sodium aluminate. As disclosed in JP 56-120508 A, an aluminum hydrate which is amorphous in X-ray diffraction can also be used by subjecting it to heat treatment at 50° C. or higher in the presence of water and converting its structure into the boehmite structure. As a process usable especially preferably in the present invention, an aluminum compound can be obtained by adding an acid to a long-chain aluminum alkoxide and conducting its hydrolysis and deflocculation.

The term “long-chain aluminum alkoxide” as used herein means an alkoxide having 5 or more carbon atoms. Use of an aluminum alkoxide having 12 to 22 carbon atoms is preferred because such a long-chain aluminum alkoxide facilitates elimination of the alcoholic moiety and shape control of the resulting aluminum hydrate as will be described subsequently herein. As the acid to be added, one or more acids can be chosen at will from organic acids and inorganic acids, and can be used. Nitric acid is most preferred from the stand point of the efficiency of the hydrolytic reaction and the shape control and dispersibility of the resulting aluminum hydrate. Subsequent to this step, a hydrothermal synthesis can be conducted to control the particle size. When the hydrothermal synthesis is conducted by using an aluminum hydrate dispersion which contains nitric acid, the nitric acid in the dispersion is attracted as nitrate groups on surfaces of the aluminum hydrate so that the aluminum hydrate is improved in water dispersibility.

The above-described process has a merit in that, compared with production processes of alumina hydrogel or cationic alumina, impurities such as various types of ions can be hardly mixed in. Further, a long-chain aluminum alkoxide has another merit in that, because an alcohol can be readily eliminated subsequent to hydrolysis, the dealcoholation of the aluminum hydrate can be effected completely compared with use of a short-chain alkoxide such as aluminum isopropoxide.

By further processing a dispersion of the aluminum hydrate synthesized by the above-described process by a physical means such as a grinding mill or the like, the particle size of the aluminum hydrate can be controlled to a desired particle. As the grinding mill, anyone of various known mills can be used. Illustrative are high-pressure homogenizers, ultrasonic homogenizers, wet-type media mills (sand mills, ball mills), continuos high-speed agitator mills, and ultrasonic mills. Specific examples include Manton-Gaulin homogenizer, sonolator (manufactured by Doyei Shoji Co., Ltd.), microfluidizer (manufactured by Mizuho Industrial Co., Ltd.), nanomizer (manufactured by Tsukishima Kikai Co., Ltd.), altimizer (manufactured by ITOCHU SANKI CORPORATION), pearl mill, Glenmill and Tornado (manufactured by Asada Iron Works Co.,Ltd.), viscomill (manufactured by Aimex Co., Ltd.), mighty mill, RS mill, ST mill (manufactured by INOUE MFG., INC.), “Ebara Milder” (trademark, manufactured by Ebara Corporation), fine flow mill, and cabitron (manufactured by Pacific Machinery & Engineering Co., Ltd.).

When the aluminum hydrate having the boehmite structure or pseudo-boehmite structure is used as a water dispersion, one having a zeta (ζ) potential of +40 mV or higher at pH 3.5 to 4.5 is preferred. When the value of the zeta (ζ) potential is +40 mV or higher, electrostatic repulsions between aluminum hydrate particles become stronger so that the dispersion is provided with higher stability. If the value of the zeta (ζ) potential falls below +40 mV, however, aluminum hydrate particles may become prone to flocculation. Further, additives commonly employed to adjust coating formulations may lower the zeta (ζ) potential of an aluminum hydrate dispersion. To keep a coating formulation, which contains such additives, stably dispersed, a higher zeta potential value is more preferred.

When fine solid particles are dispersed in a solvent, the particles are generally charged positive or negative so that counterions, which have the opposite sign to the particles, are electrostatically attracted to the surfaces of the fine solid particles. As the counterions are diffuse under thermal motion, on the other hand, the counter ions form such an ion distribution (ion atmosphere) that the density counter ions is high in the proximity of a solid surface and becomes gradually lower as the distance from the solid surface increases, that is, a diffuse electric double layer. This diffuse electric double layer includes a layer called “Stern layer” which is held on the solid surface owing to strong attraction of counter ions especially in the proximity of the solid surface, and an ion atmosphere located on an outer side of the Stern layer is called “diffuse layer”. In general, an electrical potential at the surface of a solid particle can be divided, from the one closest to the solid surface, into a surface potential, a Stern potential at the center plane of the Stern layer, and a zeta potential as defined in the present invention (i.e., a potential at a sliding surface located close to a boundary between the Stern layer and a diffuse layer (sliding surface: when a solid particle is subjected to electrophoresis, the diffuse layer located on the outer side of the sliding surface moves slower than the mobilities of the surface of the fine solid particle and the Stern layer). A zeta potential can be readily measured by using, for example, an electrophoretic light-scattering photometer, “ELS-8000” (trade name, manufactured by OTSUKA ELECTRONICS CO., LTD.), or the like. The absolute value of a measurement value increases, inter-particle repulsions become stronger so that the solid particles are provided with better dispersion stability.

(Water-Soluble Resin and Water-Dispersible Resin)

Illustrative of the water-soluble resin and/or water-dispersible resin which is included in the ink-receiving layer are starch, gelatin and casein, and modified products thereof; cellulose derivatives such as methylcellulose, carboxymethylcellulose and hydroxyethylcellulose; completely or partially saponified polyvinyl alcohols and modified products thereof (including those modified with cations, anions, silanols or the like); urea resins; melamine resins; epoxy resins; epichlorohydrin resins; polyurethane resins; polyethylene-imine resins; polyamide resins; polyvinyl pyrrolidone resins; polyvinyl butyral resins; poly(meth)acrylic acid and copolymers thereof; acrylamide resins; maleic anhydride copolymers; polyester resins; SBR latex; NBR latex; methyl methacrylate-butadiene copolymer latex; acrylic polymer latexes such as acrylate ester copolymers; vinyl polymer latexes such as ethylene-vinyl acetate copolymer; and functional-group-modified polymer latexes formed by bonding cationic groups or anionic groups to a variety of these polymer latexes.

Preferred is polyvinyl alcohol obtained by hydrolyzing polyvinyl acetate and having an average polymerization degree of from 300 to 5,000. Its saponification degree may preferably be from 70 to lower than 100 molar %, with 80 to 99.5 molar % being particularly preferred. These water-soluble resins and/or water-dispersible resins can be used either singly or in combination.

As the amount of the water-soluble resin and/or water-dispersible resin (A) to be used, the mixing weight ratio (A:B) of the water-soluble resin and/or water-dispersible resin to the aluminium hydrate (B) may preferably be in a range of from 1:30 to 1:1, with an A:B range of from 1:20 to 1:3 being more preferred. Setting of the proportion of the water-soluble resin and/or water-dispersible resin within this range makes it possible to provide the resulting ink-receiving layer with resistance to crazing or separation as dust and also with good ink absorbency.
(Thiodipropionic Acid or its Salt)

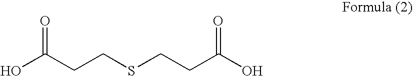

Thiodipropionic acid of the above structural formula may be used either as is, that is, in the form of a free acid (unneutralized) or in the form of a salt. Examples of bases, which form salts with thiodipropionic acid, include inorganic compounds containing metal atoms such as lithium, sodium, potassium, magnesium, calcium and zinc; and amine compounds such as ammonium, methylamine, ethylamine, monoethanolamine, diethanolamine and triethanolamine.

(Tocopherol or its Derivative)

Tocopherol and its derivatives, which are usable in the present invention, are structurally represented by the below-described formula (3). In the formula, R¹ represents a hydrogen atom or an acyl or mesyl group (e.g., acetyl, propionyl, benzoyl, or the like), and R², R³ and R⁴ each independently represents a hydrogen atom or a methyl group. Tocopherol and its derivatives, which are represented by the formula (3), each includes its D-isomer and L-isomer. Tocopherol and its derivatives can be used either singly or in combination.

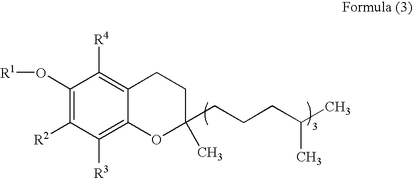

Specific examples of tocopherol and its derivatives represented by the formula (3) include, but not limited to, the following compounds:

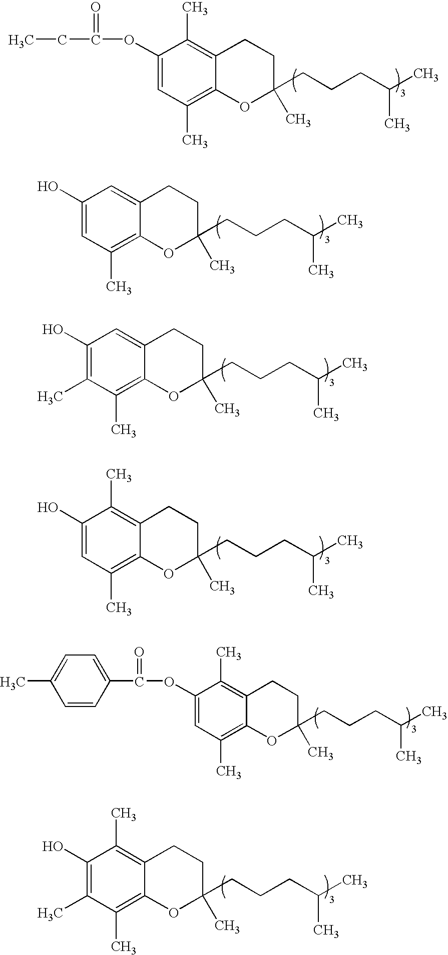

The total proportion of thiodipropionic acid or its salt thereof and tocopherol or its derivative may preferably be from 1 to 20 wt. % based on the proportion of the inorganic pigment. A total proportion smaller than 1 wt. % may not be able to bring about sufficient improvements in gas fastness and light fastness as desired. A total proportion greater than 20 wt. %, on the other hand, may lead to deteriorations in ink absorption properties.

Further, the weight ratio of thiodipropionic acid or its salt to tocopherol or its derivative may preferably be in a range of from 9:1 to 1:9. When the weight ratio of thiodipropionic acid or its salt to tocopherol or its derivative falls within this range, images can be protected more effectively from acidic gas in the air and also from light, and at the same time, alteration of the cyan tone which is important in photographic images can be more effectively inhibited.

(Cationic Resin)

In the present invention, a cationic resin can also be used in combination as needed. A cationic resin is generally used as a dye fixative to permit formation of images with improved waterproofness on a recording medium. Such a dye fixative forms a salt with a dye having one or more anionic groups and makes the dye insoluble in water, so that images can be formed with improved waterproofness.

Cationic resins usable in the present invention are oligomers or polymers of primary to tertiary amines or quaternary ammonium salts. These oligomers or polymers exhibit cationic character when dissolved in water. Particularly preferred are dimethylamine-epichlorohydrin polycondensation product, acrylamide-diallylamine copolymer, polyvinylamine copolymers, dicyandiamide, polydimethyldiallylammonium chloride, and copolymers containing them as principal blocks.

As the arrangement of monomer units in the polymer chain in each of the above-described cationic resin, any structure is usable so that the cationic resin can be in a random, alternate, block or multi-block copolymerization form. No particular limitation is imposed on the molecular weight or molecular weight distribution. In view of the viscosity when formulated into an aqueous solution, however, the weight average molecular weight can preferably be from 5,000 to 200,000.

When a cationic resin is employed in the present invention, its proportion may preferably be in a range of from 0.1 to 10 wt. % based on the inorganic pigment. A proportion smaller than 0.1 wt. % may not be effective for waterproofness, where as a proportion greater than 10 wt. % may result in a coating formulation the viscosity of which varies substantially with time to exhibit inferior coating work stability or may result in an image altered in tone as a whole or reduced in light fastness.

(Boron Compound)

In the present invention, a boron compound may also be used like the above-described cationic resin. The boron compound for use in the present invention may preferably be an oxyacid formed around a boron atom as a center or a salt thereof, such as boric acid or a borate salt. Specific examples include orthoboric acid, metaboric acid, hypoboric acid, tetraboric acid and pentaboric acid, and salts thereof.

Boric acid is commonly used as a hardener for improving the film-forming properties, waterproofness and film strength of films formed of hydrophilic polymers. Depending upon the types of reactive groups contained in polymers to be used, various hardeners are chosen, respectively. In the case of a polyvinyl alcohol resin, for example, an epoxy hardener or an inorganic hardener such as boric acid or a water-soluble aluminum salt is used. However, the role of the boron compound in the present invention is to increase the fading preventing effect or the discoloration preventing effect for images when incorporated especially in the ink-receiving layer formed on the base material, and therefore, is different from that of the same compound in the application where its utility is limited to the effect as a hardener.

To bring about both of the synergistic effect for the prevention of fading and discoloration of images and the good coating work stability, the boron compound may be used preferably in a proportion of from 0.5 to 5 wt. % based on the aluminum hydrate, with 1 to 5 wt. % being more preferred. A proportion smaller than 0.5 wt. % may lead to development of an inconvenience such that an ink-receiving layer formed on a base material may craze. A proportion greater than 5 wt. %, on the other hand, may result in gelation of a coating formulation or may lead to a deterioration in coating work stability.

(Coating Formulation)

The recording medium according to the present invention can be obtained by mixing the essential components, which consist of the inorganic pigment, the water-soluble resin and/or water-dispersible resin, thiodipropionic acid or its salt, and tocopherol or its derivative, and other optional components with an aqueous medium in an amount as much as needed into a coating formulation, applying the coating formulation to a surface of a base material and then drying the thus-applied coating formulation into an ink-receiving layer.

As the construction of the recording medium according to the present invention, it is possible to choose inter alia a construction with one or more ink-receiving layers arranged on a base material, a construction with thiodipropionic acid or its salt and tocopherol or its derivative overcoated on an ink-receiving layer, or a construction with an ink-receiving layer formed by applying a small amount of a coating formulation to a surface of a base material. In the present invention, these constructions shall all be embraced by the expression that “an ink-receiving layer is formed on a surface of a base material”.

No particular limitation is imposed on the aqueous medium in the coating formulation, insofar as it is water or a mixture of water and a water-miscible organic solvent. Examples of the water-miscible organic solvent include alcohols such as methanol, ethanol and propanol; lower alkyl ethers of polyhydric alcohols, such as ethylene glycol monomethyl ether and ethylene glycol dimethyl ether; ketones such as acetone and methyl ethyl ketone; and ethers such as tetrahydrofuran.

No particular limitation is imposed on the concentration of solids in the coating formulation adapted to form an ink-receiving layer, insofar as the coating formulation has a viscosity sufficient to form the ink-receiving layer on the base material. The preferred solid concentration may, however, range from 5 to 50 wt. % based on the whole weight of the coating formulation. A solid concentration lower than 5 wt. % leads to a need for increasing the coat weight to form an ink-receiving layer of sufficient thickness. As longer time and greater energy are required for drying, such a low solid concentration may not be economical in some instances. A solid concentration higher than 50 wt. %, on the other hand, may result in a coating formulation of high viscosity, and the coatability may be reduced in some instances.

To the coating formulation, various additives can be added to extents not impairing the advantageous effects of the present invention. Examples of such additives include surfactants, pigment dispersants, thickeners, defoamers, ink-fixing agents, dot adjusters, colorants, fluorescent whitening agents, antioxidants, ultraviolet absorbers, preservatives, and pH adjusters.

As a method for applying the thus-prepared coating formulation onto the base material, a known, desired coating method can be used. For example, coating is feasible by coating methods such as blade coating, air knife coating, curtain coating, slot die coating, bar coating, gravure coating and roll coating. The thus-coated base material is then dried using a drier such as a hot air drier, hot drum or far-infrared drier to form an ink-receiving layer. The ink-receiving layer may be formed by changing the proportions of the fine inorganic particles, the water-soluble resin and/or water-dispersible resin and the other additives, and can be formed on one side or each side of the base material. Further, smoothening processing may be applied using a machine such as a super calender and a soft calender, for example, in order to provide images with an improved resolution and the recording medium with improved feedability.

A preferred range of the coat weight of the coating formulation on the base material can be from 0.5 to 60 g/m² in terms of solids, with a range of from 5 to 55 g/m² being more preferred. A coat weight smaller than 0.5 g/m² results in the formation of an ink-receiving layer, which may not be able to sufficiently absorb water from an ink so that the ink may run or images may bleed in some instances. A coat weight greater than 60 g/m², on the other hand, may develop curling upon drying or may not be able to bring about the advantageous effect to such pronounced extent as expected on the printing performance.

Although it is not clear why the recording medium of the present invention as described above permits printing of excellent quality and especially exhibits superb effects for the prevention of fading and discoloration of images by gas and light and also for the inhibition of alteration of the cyan tone, a certain interaction appears to take place between thiodipropionic acid or its salt and tocopherol or its derivative to develop such effects.

No particular limitation is imposed on ink to be used upon making a record on the recording medium according to the present invention. It is, however, preferred to use general water-base ink for ink-jet recording, in which a dye or inorganic pigment is used as a colorant, a mixture of water and a water-miscible organic solvent is used as a medium, and the dye or pigment is dissolved or dispersed in the medium.

As a method for performing the formation of an image by applying the above-described ink onto the recording medium, ink-jet recording is particularly suited. Any ink-jet recording method can be used insofar as it can apply an ink to the recording medium by effectively causing the ink to fly off from a nozzle. A particularly useful method is an ink-jet recording method such as that disclosed in JP 54-59936 A or the like, in which as a result of exposure to action of thermal energy, an ink undergoes a rapid change in volume and the resulting force ejects the ink from a nozzle.

### EXAMPLES

The present invention will hereinafter be described specifically based on Examples, in which each designation of “part” or “parts” or “%” is on a weight basis unless otherwise specifically indicated.

<Production of Aluminum Hydrate>

Following the process disclosed in U.S. Pat. No. 4,242,271, aluminum dodexide was prepared. Following the process disclosed in U.S. Pat. No. 4,202,870, the aluminum dodexide was then hydrolyzed to prepare an alumina slurry. Water was added to the alumina slurry until the solid content of an aluminium hydrate reached 7.7%. At that time, the pH of the alumina slurry was 9.4. A 3.9% nitric acid solution was added to the slurry to adjust its pH to 6.0.

Using an autoclave, the slurry was then subjected to aging (aging temperature: 150° C., aging time: 6.0 hours) to obtain a colloidal sol. The colloidal sol was spray-dried into an aluminium hydrate powder at an inlet temperature of 87° C. The powder so obtained was an aluminium hydrate, the particle shape and crystal structure of which were plate-like and the boehmite structure, respectively. Further, the aluminium hydrate powder having the boehmite structure was mixed at a concentration of 19% in deionized water to prepare an aluminium hydrate dispersion A.

The dispersion A obtained by the above-described procedure was redispersed by an ultrasonic homogenizer, “MUS-600CCVP-12” (trade name; manufactured by Nihon Seiki Seisakusho Co., Ltd.). Coarse particles were then removed by centrifugation, followed by the addition of deionized water to prepare an aluminium hydrate dispersion B the concentration of which was 17%.

The average particle size and polydisperse index of the ( thus-obtained aluminum hydrate dispersion B were measured by using a laser diffraction particle size analyzer, “PARIII” (trade name, manufactured by OTSUKA ELECTRONICS CO., LTD.), and its zeta potential was measured by using a laser-based zeta potentiometer, “ELS-6000” (trade name, manufactured by OTSUKA ELECTRONICS CO., LTD.). As a result, the average particle size was found to be 178.5 nm, the polydisperse index was determined to be 0.1143, and the zeta potential at pH 4.2 was found to be +58.6 mV.

Preparation of a Recording Medium 1

To the aluminum hydrate dispersion B (100 parts; solid content: 17 parts), a 3% aqueous solution of boric acid (0.51 parts in terms of solid; 3% based on the aluminum hydrate) and “SumirezResin 1001” (trade name for an acrylamide-diallylamine hydrochloride copolymer; product of Sumitomo Chemical Co., Ltd.; 0.17 part in terms of solid; 1% based on the aluminum hydrate) were added to prepare a liquid mixture. On the side, polyvinyl alcohol (“PVA-235”, trade name; product of Kuraray Co., Ltd.; saponification degree: 88%; polymerizationdegree: 3,500; 1.7 parts in terms of solid) was dissolved in water (15.3 parts) to prepare a solution. Those liquid mixture and solution were mixed together to prepare a coating formulation. Using a polyethylene-coated paper (75-deg. specular gloss as measured in accordance with JIS-P8142: 77.9%) as a base material, the coating formulation prepared as described above was then applied by the bar coating method to give a dry coat weight of 35 g/m² such that an ink-receiving layer was formed. A 1:3 by weight mixture of a mixed tocopherol extract (product of Sankyo Company, Limited) and a 10% solution of thiodipropionic acid in methanol was next over-coated on the ink-receiving layer such that the tocopherol and thiodipropionic acid were added in a total solid proportion of 5% based on the aluminum hydrate to prepare a recording medium 1.

Preparation of a Recording Medium 2

A recording medium 2 was prepared in a similar manner as in the preparation of the recording medium 1 except that DL-α-tocopherol (product of Tokyo Kasei Kogyo Co., Ltd.) was used in place of the mixed tocopherol extract.

Preparation of a Recording Medium 3

A recording medium 3 was prepared in a similar manner as in the preparation of the recording medium 1 except that the mixing ratio of the mixed tocopherol extract to thiodipropionic acid was changed to 3:1.

Preparation of a Recording Medium 4

A recording medium 4 was prepared in a similar manner as in the preparation of the recording medium 1 except that the mixed tocopherol extract was not used and thiodipropionic acid was added in a proportion of 5% based on the aluminum hydrate.

Preparation of a Recording Medium 5

A recording medium 5 was prepared in a similar manner as in the preparation of the recording medium 1 except that thiodipropionic acid was not used and DL-α-tocopherol was added in a proportion of 5% based on the aluminum hydrate.

Preparation of a Recording Medium 6

A recording medium 6 was prepared in a similar manner as in the preparation of the recording medium 1 except that neither the mixed tocopherol extract nor thiodipropionic acid was over-coated.

Ranking 1: Ranking Method for Inhibitory Effects Against Fading and Discoloration by Gas

On each recording medium, solid printing was performed in an ink quantity of 100% per ink with single-color inks of a black (Bk) ink and a cyan (C) ink by using an ink-jet recording system (“BJ F870”, trade name; manufactured by Canon Inc.). The recording medium was placed in an ozone exposure testing equipment (manufactured by SUGA TEST INSTRUMENTS CO., LTD.; special order equipment), and was exposed to ozone of 1 ppm concentration for 4 hours at 40° C. and 55% R. H. Using an optical reflection densitometer (“RD-918”, trade name; manufactured by GretagMacbeth AG), the optical densities of a Bk ink image C and a C ink image were measured before and after the exposure to ozone. The percent remainder of OD of each image was calculated in accordance with the below-described formula (A). The inhibitory effects against fading and discoloration by exposure to ozone were ranked as shown below.
Percent remainder of OD=(OD after test/OD before test)×100% (A)
A: Percent remainder of OD≧90%
B: 90%>Percent remainder of OD≧80%
C: 80%>Percent remainder of OD
   Ranking 2: Rankingmethod for Inhibitory Effects Against Fading and Discoloration by Light

On each recording medium, solid printing was performed in an ink quantity of 100% per ink with single-color inks of a black (Bk) ink and a magenta (M) ink by using an ink-jet recording system (“BJ F870”, trade name; manufactured by Canon Inc.). The recording medium was stored for 100 hours in an Atlas Fade-O-Meter (conditions: exposure intensity at 340 nm wavelength: 0.39W/m², temperature: 45° C., humidity: 50% R. H.). Using an optical reflection densitometer (“RD-918”, trade name; manufactured by Gretag Macbeth AG), the optical densities of a Bk ink image and an M ink image were measured before and after the storage in “Atlas Fade-O-Meter”. The percent remainder of OD of each image was calculated in accordance with the below-described formula (A). The inhibitory effects against fading and discoloration by exposure to light were ranked in three stages as in the ranking 1.

Ranking 3: Ranking Method for Preventive Effect Against Alteration of the Cyan Tone

On the recording medium 5 on which no over-coating had been applied, solid printing was performed in an ink quantity of 100% with the C ink by using the inkjet recording system “BJ F870”. Using a spectral color-difference meter, ZE2000” (trade name; manufactured by Nippon Denshoku Industries Co., Ltd.), the L*a*b* values (the coordinates on the L*a*b* calorimetric system according to the color difference method as defined by CIE) of a C ink image were measured. Using these values as references, their differences from the L*a*b* values of a C ink image printed on another recording medium were ranked in three stages by using ΔE* defined by the following formula (B):
ΔE*=[(ΔL*)²+(Δa*)²+(Δb*)²]^{1/2} (B)
wherein ΔL*, Δa* and Δb* mean differences in the L*, a* and b* coordinates on the L*a*b* colorimetric system between the C ink image printed on the recording medium 1 and the C ink image printed on another recording medium.

A: ΔE*<10

B: 10≦ΔE*<20

C: 20≦ΔE*

Ranking 4: Ranking Method for Ink Absorption Properties

By the inkjet recording system “BJ F870”, the C ink and a yellow (Y) ink were solid-printed in an ink quantity of 100% per color on each recording medium such that a green (G) ink was solid-printed in a total ink quantity of 200%. By visual observation, ink absorption properties upon printing were ranked depending upon whether or not beading occurred. The term “beading” means a phenomenon that, when recording is performed by an inkjet printer on a recording medium having insufficient ink absorption properties, ink droplets adhered on the recording medium merge together on the surface of the recording medium to result in an image with uneven color.

A: No beading occurred.

B: Beading occurred.

### Example 1

Using the recording medium 1, the rankings 1-4 were performed. The results are presented in Table 1.

### Example 2

Using the recording medium 2, the rankings 1-4 were performed. The results are presented in Table 1.

### Example 3

Using the recording medium 3, the rankings 1-4 were performed. The results are presented in Table 1.

### Comparative Example 1

Using the recording medium 4, the rankings 1-4 were performed. The results are presented in Table 1.

### Comparative Example 2

Using the recording medium 5, the rankings 1-4 were performed. The results are presented in Table 1.

### Comparative Example 3

Using the recording medium 6, the rankings 1-4 were performed. The results are presented in Table 1.

TABLE 1
Ranking Results

| | Ranking 1 | | Ranking 2 | | Ranking 3 | |
|---|---|---|---|---|---|---|
| | Bk | C | Bk | M | ΔE* | Ranking 4 |
| Ex. 1 | A | A | A | A | A | A |
| Ex. 2 | A | A | A | A | A | A |
| Ex. 3 | A | A | A | A | A | A |
| Comp. Ex. 1 | A | A | A | A | B | A |
| Comp. Ex. 2 | A | A | B | B | A | B |
| Comp. Ex. 3 | C | C | C | B | A | A |

As evident from the ranking results presented above in Table 1, the recording of images on the recording media of the Examples, which contained both thiodipropionic acid and tocopherol in their ink-receiving layers, successfully prevented alteration of the cyan tone shortly after the recording and also successfully prevented discoloration and fading of the images by gas or light over a long term, whereas the recording of images on the recording media of the Comparative Examples, which contained only one or neither of thiodipropionic acid and tocopherol in their ink-receiving layers, exhibited only some of the advantageous effects, which were brought about owing to the inclusion of both of thiodipropionic acid and tocopherol, and failed to exhibit all the advantageous effects together.

### INDUSTRIAL APPLICABILITY

The inclusion of an aluminum hydrate of the boehmite or pseudo-boehmite structure, a water-soluble resin and/or water-dispersible resin, thiodipropionic acid or its salt, and tocopherol or its derivative in an ink-receiving layer has made it possible to provide a recording medium which exhibits excellent ink absorption properties and which can form an image having high print density, equipped with print quality comparable with silver halide pictures, and protected from fading or discoloration by acidic gas in the air and/or light so that they are reduced in the alteration of the cyan tone.

1. A recording medium provided on at least one of opposite sides thereof with at least one ink-receiving layer, characterized in that said ink-receiving layer comprises an inorganic pigment, a water-soluble resin and/or water-dispersible resin, thiodipropionic acid or a salt thereof, and tocopherol or a derivative thereof.

2. A recording medium according to claim 1, wherein thiodipropionic acid or its salt and tocopherol or its derivative are added in a total proportion of from 1 to 20 wt. % based on said inorganic pigment.

3. A recording medium according to claim 1, wherein said inorganic pigment is an aluminum hydrate having the boehmite or pseudo-boehmite structure.

4. A recording medium according to claim 3, wherein a water dispersion of said aluminum hydrate has a zeta (ζ) potential of +40 mV or higher at pH 3.5 to 4.5.

5. A recording medium according to claim 3, wherein said ink-receiving layer further comprises a boron compound.

6. An inkjet recording medium comprising a recording medium according to claim 1.
